(19) United States
(12) Patent Application Publication
(10) Pub. No.: US 2025/0269666 A1
(43) Pub. Date: Aug. 28, 2025

(54) PRINTING APPARATUS, PRINTING METHOD, AND STORAGE MEDIUM

(71) Applicant: CANON KABUSHIKI KAISHA, Tokyo (JP)

(72) Inventors: KENGO NIEDA, Kanagawa (JP); KAZUKI NARUMI, Tokyo (JP); MASAHIRO SUGIMOTO, Kanagawa (JP); TOMOKAZU ISHIKAWA, Kanagawa (JP); SHO NAKAMURA, Tokyo (JP)

(21) Appl. No.: 19/055,813

(22) Filed: Feb. 18, 2025

(30) Foreign Application Priority Data
Feb. 26, 2024 (JP) 2024-026249

(51) Int. Cl. B41J 11/00; B41J 11/42; B41J 29/393

(52) U.S. Cl. CPC B41J 11/0022; B41J 11/42; B41J 29/393

(57) ABSTRACT

The technique of the present disclosure reduces color misregistration in a printing apparatus that incorporates a drying process during a printing process. In a printing apparatus that performs drying between a first recording unit and a second recording unit, a first misregistration amount between the recording units, i.e., the first recording unit and the second recording unit. Based on the calculated first misregistration amount between the printing units as well as a pattern printed in a second area for detecting misregistration between the first recording unit and the second recording unit, a second misregistration amount between the recording units, which is caused by the scaling of the sheet in the conveyance direction due to heating and cooling, is calculated. According to the calculated second misregistration amount between the recording units, a scaling process is performed on the image data for the first recording unit.

### BACKGROUND

### Field

The present disclosure relates to a control technique for a printing apparatus that performs drying of the recording medium after printing.

### Description of the Related Art

In recent years, there has been a demand for high definition white and color printing in printing apparatuses that perform recording on a recording medium using an inkjet scheme. For this reason, there are also printing apparatuses which have separate recording units for white and color and have a drying unit installed between them. By installing a drying unit between the white recording unit and the color recording unit in such a printing apparatus, it is possible to record an image without mixed color from the white ink and the color ink. Japanese Patent Laid-Open No. 2019-005716 discloses a printing apparatus employing a method for printing white and color on a film, in which the color printing is carried out using an inkjet printer, the white printing is carried out using gravure roll coating of white ink, and a drying process is carried out downstream of each printing process. Moreover, in the printing apparatus described in Japanese Patent Laid-Open No. 2019-005716, the film is heated and then cooled, thereby suppressing deformation of the film such as scaling, and waviness.

### SUMMARY

The present disclosure is characterized by a printing apparatus including: a first recording unit configured to record a first image on a front surface of a recording medium, which has the front surface and a back surface; a drying unit configured to dry the recording medium on which the first image is recorded by the first recording unit; a second recording unit configured to record a second image on the front surface of the recording medium dried by the drying unit; and a control unit configured to control a recording position of the first recording unit or a recording position of the second recording unit in accordance with scaling of the recording medium caused by being dried by the drying unit.

Further features of the present disclosure will become apparent from the following description of exemplary embodiments with reference to the attached drawings.

### BRIEF DESCRIPTION OF THE DRAWINGS

FIG. 1 is a schematic diagram illustrating the internal configuration of a printing apparatus;

FIG. 2 is a perspective view of a sheet conveyance unit housing of a recording unit according to an embodiment;

FIG. 3 is a perspective view of a recording head lifting mechanism according to the embodiment;

FIG. 4 is a block diagram of a control unit of the printing apparatus according to the embodiment;

FIG. 5 is a flowchart illustrating the processing from printing a maintenance pattern to reading the printed maintenance pattern in the embodiment;

FIG. 6A is a diagram illustrating the maintenance pattern A printed with each of the two recording units in the embodiment;

FIG. 6B is a diagram illustrating the maintenance pattern B printed with each of the two recording units in the embodiment;

FIG. 7 is a diagram for explaining a maintenance pattern obtained by superimposing the maintenance patterns A and B as well as the patterns in each area in the embodiment; and

FIG. 8 is a flowchart illustrating the processing for calculating the misregistration amounts from the read maintenance pattern in the embodiment.

### DESCRIPTION OF THE EMBODIMENTS

Hereinafter, embodiments of the present disclosure are specifically explained with reference to the drawings. Note that the components described in the following embodiments are merely examples, and the configuration and various conditions of the apparatus to which the present disclosure is applied can be modified or changed as appropriate without departing from the gist of the present disclosure, and are not limited to the following embodiments. For example, the dimensions, materials, shapes, and relative arrangements of the components described in the following embodiments can be changed as appropriate depending on the configuration and various conditions of the apparatus to which the present disclosure is applied, and unless otherwise specified, the present disclosure is not limited to the following embodiments.

However, while the technique described in Japanese Patent Laid-Open No. 2019-005716 can suppress large deformations of the recording medium with the temperature management, it cannot suppress slight scaling that varies in each recording medium due to residual stresses in the manufacturing process of the recording medium, resulting in the issue of color misregistration caused by the scaling of the recording medium.

Therefore, an object of the present disclosure is to reduce color misregistration in a printing apparatus that carries out a drying process between printing processes.

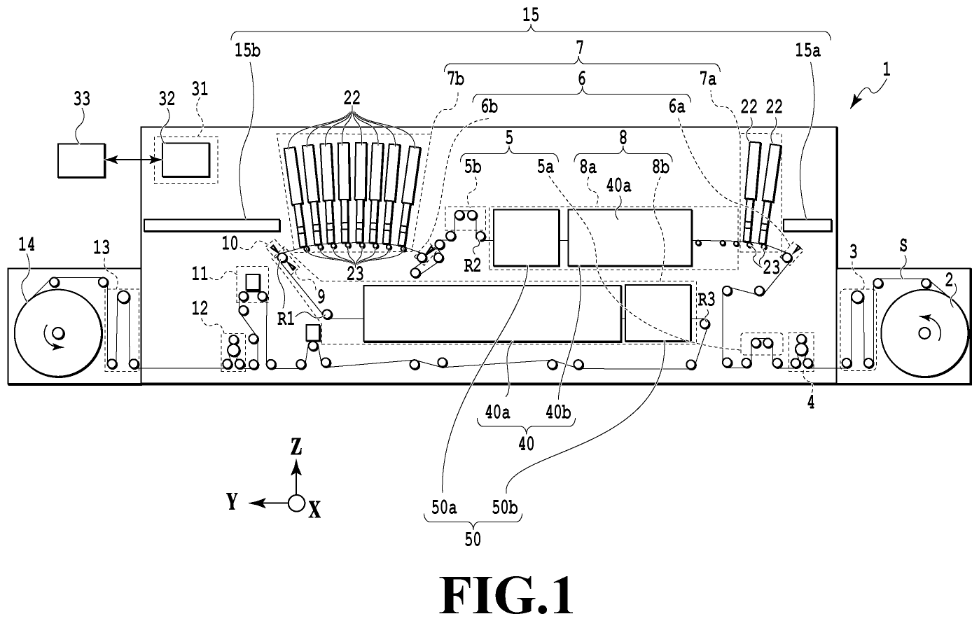

First, the upper side of the apparatus in FIG. 1 is defined as the upper side, the direction from the right to left as the longitudinal direction, and the direction from the front to back of the paper surface, perpendicular to the recording medium conveyance direction, as the sheet width direction. The printing apparatus 1 is a high-speed line printer that uses a continuous sheet wound in a roll as the recording medium.

### Printing Apparatus

In FIG. 1, a schematic cross-sectional view of the printing apparatus 1 according to the present embodiment is illustrated. The printing apparatus 1 of the present embodiment is equipped with a conveyance mechanism that includes the unwinding unit 2, the first dancer roller unit 3, the first main conveyance unit 4, the meandering correction unit 5, the conveyance detection unit 6, the conveyance tensile force detection unit 9, the second main conveyance unit 12, the second dancer roller unit 13, and the winding unit 14. Further, the printing apparatus 1 is equipped with a recording mechanism that includes the recording unit 7, the recorded image position detection unit 10, the scanner unit 11, the maintenance unit 15, the drying unit 40, and the cooling unit 50. The continuous sheet S, which is a recording medium, is conveyed along the sheet conveyance path illustrated with the solid line in the drawing, and is processed by each unit. Note that, in the present embodiment, the drying unit 40 and the cooling unit 50 are distinguished from each other, but the drying unit 40 and the cooling unit 50 may be combined into a drying unit.

The printing apparatus 1 has a configuration for carrying out the first recording process and the second recording process along the sheet conveyance path. In the first recording process, an image is fixed and recorded on the sheet S via the first recording unit 7a, the first drying unit 40a, and the first cooling unit 50a. In the second recording process, an image is fixed and recorded via the second recording unit 7b, the second drying unit 40b, and the second cooling unit 50b on the sheet S which has passed through the first recording process. In this manner, the printing apparatus 1 carries out the above-described first recording process and second recording process on the sheet S, thereby making it possible to continuously record images on the sheet S in an overlapping manner without mixed colors. Further, the printing apparatus 1 is also capable of selectively choosing a recording process in accordance with the printing condition, and may record an image on the sheet S by carrying out only the selected recording process. Note that the conveyance of the sheet S from the unwinding unit 2 to the winding unit 14 is defined as a forward conveyance, and the conveyance in the opposite direction is defined as an opposite direction conveyance.

The unwinding unit 2 is a unit for holding and supplying the roll sheet, which is a continuous sheet wound into a roll. The unwinding unit 2 is configured to store a roll sheet and supply the sheet S by pulling out the roll sheet. Note that the number of roll sheets that can be stored is not limited to one, and a configuration in which multiple roll sheets are stored and the sheet S is supplied by pulling out one of the multiple roll sheets may be used. Note that the unwinding unit 2 is controlled to rotate in both forward and reverse directions by a motor (not illustrated in the drawings).

The first dancer roller unit 3 is a unit for applying constant sheet tensile force between the unwinding unit 2 and the first main conveyance unit 4 by a tensile force applying unit that is not illustrated in the drawings.

The first main conveyance unit 4 is a unit for feeding the sheet S to each unit installed along the sheet conveyance path while applying sheet tensile force in cooperation with the second main conveyance unit 12, and is driven by a motor that is not illustrated in the drawings to convey the sheet S under tensile force.

The meandering correction unit 5 is a unit for correcting meandering in the sheet width direction during conveyance of the sheet S under tensile force. In the present embodiment, the meandering correction unit 5 includes the first meandering correction unit 5a and the second meandering correction unit 5b, which are installed upstream of the respective recording process in the sheet conveyance path. The meandering correction unit 5 is configured with a meandering correction roller and a meandering detection sensor (not illustrated in the drawings) that detects meandering of the sheet S. The meandering correction roller can change the inclination with respect to the sheet S using a motor that is not illustrated in the drawings, and performs correction of the meandering of the sheet S based on the measurement result from the meandering detection sensor. The meandering correction unit 5 enhances the meandering correction function by winding the sheet S around the meandering correction roller.

The conveyance detection unit 6 is a unit for detecting a predetermined detection mark printed in advance on the sheet S in order to control the recording timing of the image in the recording unit 7. In the present embodiment, the conveyance detection unit 6 includes the first conveyance detection unit 6a and the second conveyance detection unit 6b, which are installed upstream of the recording process in the sheet conveyance path. The first conveyance detection unit 6a and the second conveyance detection unit 6b are used to control the recording timing of the images in the first recording unit 7a and the second recording unit 7b, respectively.

The recording unit 7 applies a liquid composition (ink) onto the conveyed sheet S from above using the recording heads 22 to form an image. The sheet conveyance path in the recording unit 7 is configured with the guide rollers 23 arranged in an upwardly convex arc shape, and a constant tension is applied to the sheet S, thereby ensuring a constant clearance between the sheet S and the recording heads 22. The multiple recording heads 22 are installed in the recording unit 7 along the conveyance direction. In the present embodiment, the first recording unit 7a includes a total of two line-type recording heads corresponding to the W (white) ink and a reactive liquid. The second recording unit 7b includes a total of eight line-type recording heads corresponding to the four colors of Bk (black), Y (yellow), M (magenta), and C (cyan), as well as the reactive liquid and three spot colors. The reactive liquid is a liquid containing a component that increases the viscosity of the ink. Here, an increase in the viscosity of the ink refers to a state in which the coloring material, resin, or the like that constitutes the ink comes into contact with a component that increases the viscosity of the ink, causing a chemical reaction or physical adsorption, resulting in an increase in the viscosity of the ink. An increase in the viscosity of the ink is not limited to an increase in the viscosity of the entire ink but also includes a localized increase in viscosity caused by the partial aggregation of components such as coloring materials and resins that constitute the ink. The component that increases the viscosity of the ink is not particularly limited and may be a metal ion, a polymer coagulant, etc. Further, substances that induce a pH change in the ink to coagulate the color material, such as organic acids, can also be used. If the reactive liquid is applied before the ink is applied onto the sheet S, the ink that reaches the sheet S can be fixed immediately. As a result, bleeding, where adjacent inks mix with each other, can be suppressed.

Note that the color types and the number of colors and the number of the recording heads 22 are not limited to those in the present embodiment. In the inkjet scheme, it is possible to adopt a method using heating elements, a method using piezoelectric elements, a method using electrostatic elements, a method using MEMS elements, or the like. The ink is supplied to the recording heads 22 from ink tanks that are not illustrated in the drawings via ink tubes.

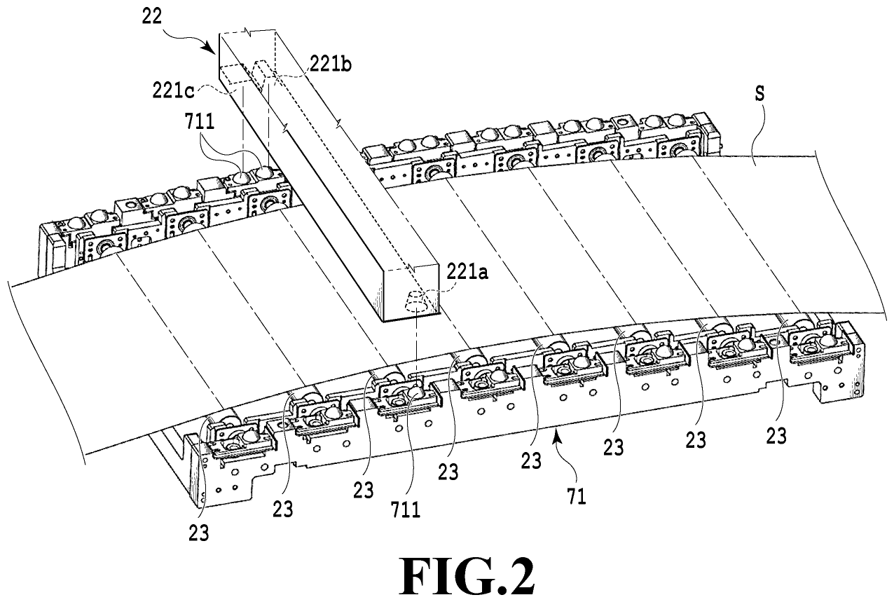

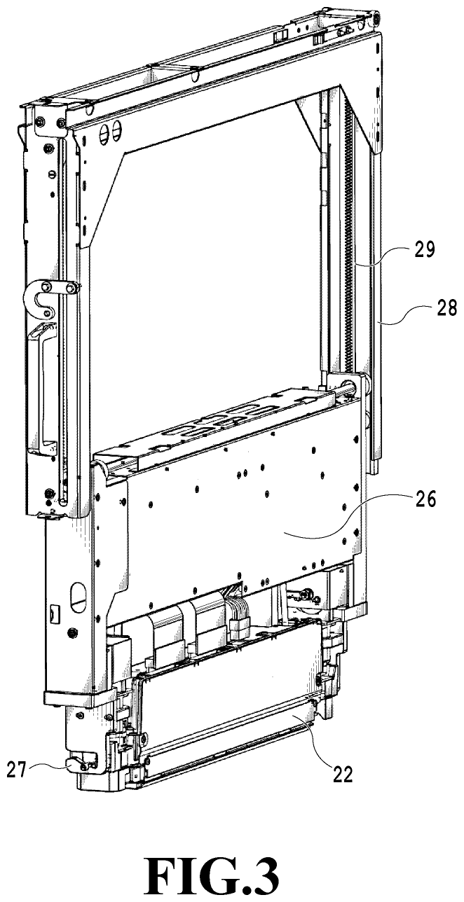

As illustrated in FIG. 2, the multiple recording head positioning members 711 for performing positioning of the recording heads 22 are installed on the sheet conveyance unit housing 71 of the recording unit 7. In the present embodiment, the recording head positioning members 711 are installed on the front and rear sides of each recording head 22 in the sheet width direction, with the sheet S sandwiched between the members, one on the front side and two on the rear side. Further, as illustrated in FIG. 3, each recording head 22 is supported via an axis by the recording head holding unit 26, which holds the recording head 22 and lifts up and down, in such a manner that the recording head support shaft 27 is supported from below. The recording head holding unit 26 uses a drive mechanism (not illustrated in the drawings) installed therein to perform a lifting operation up and down along the lift rail 29 installed in the recording head lift frame 28. Further, in the present example, ink is applied onto the sheet S using an inkjet head, but the method of applying ink onto the sheet in the recording unit 7 is not limited to this. For example, in the present example, the reactive liquid is applied by the recording heads 22, but may also be applied by a roller, a die coating device (die coater), a blade coating device (blade coater), or the like.

The conveyance tensile force detection unit 9 is a unit for detecting the tensile force at the time the sheet S is conveyed under tensile force between the first main conveyance unit 4 and the second main conveyance unit 12.

The recorded image position detection unit 10 is a unit for detecting the shift of an image formed on the sheet S by the recording unit 7 during printing, and correcting the printing.

The winding guide roller R1 is a roller that winds, at a constant winding angle, the surface of the sheet S conveyed downstream of the second recording unit 7b, on the side opposite to the ink-applied surface. In the present embodiment, the two winding guide rollers R1 are arranged between the second recording unit 7b and the second drying unit 40b, and the sheet S is folded back approximately parallel to the top and bottom of the apparatus. Further, the second drying unit 40b is arranged on the lower side of the apparatus, below the second recording unit 7b.

The drying unit 40 (the first drying unit 40a and the second drying unit 40b) is a unit that reduces the liquid content contained in the liquid composition applied onto the sheet S in the recording unit 7, and enhances the fixation of the ink to the sheet S. The drying unit 40 dries the applied ink by blowing air at a predetermined temperature onto the recorded sheet S. Inside the drying unit 40, warm air is applied to at least the ink-applied surface side of the sheet S passing through, thereby drying the ink-applied surface of the sheet S. Note that, instead of the method of applying warm air, the drying scheme may be configured as a combination of a method of irradiating electromagnetic waves (such as ultraviolet rays or infrared rays) onto the surface of the sheet S, a conductive heat transfer method involving contact with a heating element, etc.

The cooling unit 50 (the first cooling unit 50a and the second cooling unit 50b) cools the sheet S heated in the drying unit 40, solidifying the softened ink and controlling the temperature of the sheet S to an appropriate temperature for the downstream processes of the printing apparatus. Inside the cooling unit 50, air with a lower temperature than the sheet S is applied to at least the ink-applied surface side of the sheet S passing through, thereby cooling the ink-applied surface of the sheet S. Note that the cooling scheme is not limited to the method of applying air, but may be a conductive heat transfer method involving contact with a heat dissipating member or the like, or a combination of these.

The scanner unit 11 is a unit that reads a test image, a maintenance pattern, or the like formed on the sheet S by the recording unit 7 before the actual printing. The read image read by the scanner unit 11 is used by the later-described control unit 31 to detect the shift, ink density, etc., of the image printed by the recording unit 7.

The second main conveyance unit 12 is a unit that conveys the sheet S while applying tensile force to the sheet S in cooperation with the first main conveyance unit 4 and performs adjustment of the tensile force of the sheet S. The second main conveyance unit 12 is driven by a motor that is not illustrated in the drawings, and controls the conveyance speed according to a tensile force control unit that is not illustrated in the drawings in response to the tensile force value detected by the conveyance tensile force detection unit 9. Note that, as an additional configuration for adjusting the tensile force of the sheet S, a configuration for adjusting the tensile force of the sheet S by a drive-coupled clutch (not illustrated in the drawings) capable of controlling the torque may be added. In this case, two methods are available as the tensile force control methods, including a torque control method that controls the torque value transmitted from the clutch, and a speed control method that controls the roller speed of the second main conveyance unit 12. The tensile force control method can be switched according to the purpose, or both methods can be used simultaneously.

The second dancer roller unit 13 is a unit for applying a constant sheet tensile force between the second main conveyance unit 12 and the winding unit 14. The sheet tensile force is applied to the second dancer roller unit 13 by a tensile force applying unit that is not illustrated in the drawings.

The winding unit 14 is a unit for winding the sheet S onto a core after the recording process. The number of recoverable rolls is not limited to one. The configuration may include two or more winding cores, where the sheet S is recovered as multiple rolls by selectively switching between the cores. The winding unit 14 is independently controlled to rotate in both forward and reverse directions by a drive motor (not illustrated in the drawings). By controlling the respective drive motors (not illustrated in the drawings) of the unwinding unit 2 and the winding unit 14 to rotate in the forward direction or the reverse direction, the sheet S is conveyed in the forward direction or the opposite direction. In a case of the opposite direction conveyance, conveyance under tensile force is performed between the first main conveyance unit 4 and the second main conveyance unit 12 in the same manner as in the case of the forward conveyance. Note that, depending on the processing content of treating the printed sheet S after printing, a configuration in which the sheet S is cut using a cutter and the cut sheet S is stacked may be adopted, instead of the configuration in which the sheet S is wound around a core.

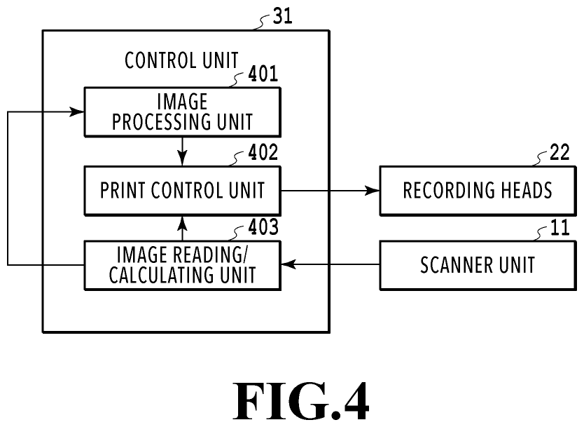

The control unit 31 is a unit responsible for controlling each unit of the entire printing apparatus. The control unit 31 has a CPU, a storage device, a controller equipped with various control units, an external interface, and the operation unit 32 where the user performs input and output. The operation of the printing apparatus 1 is controlled based on commands from the controller or the host apparatus 33, such as a host computer connected to the controller via the external interface. The control unit 31 includes the image processing unit 401, the print control unit 402, and the image reading/calculating unit 403. FIG. 4 illustrates a block diagram of the image processing unit 401, the print control unit 402, and the image reading/calculating unit 403 of the control unit 31.

The image processing unit 401 performs γ correction, color processing, binarization (halftoning), scaling processing, and the like on the recording data (multi-valued image data) transferred from a host computer or the like via the interface.

The print control unit 402 controls the recording unit 7, motors, sensors, etc., in accordance with various programs, parameters, etc., stored in the storage device for the image data loaded by the image processing unit 401, thereby printing an image on the sheet S and outputting the sheet S on which the image is printed.

The image reading/calculating unit 403 acquires the read image read by the scanner unit 11, reads the test image, maintenance pattern, or the like, calculates misregistration information, color gamut information, or the like, and transmits the calculation results to the image processing unit 401 and the print control unit 402. The image processing unit 401 and the print control unit 402 perform adjustments of the recording position of the recording unit 7. During adjustments of the recording position, in addition to adjusting the start position of recording for each of the first recording unit 7a and the second recording unit 7b, the recording position is also adjusted so that the size of the image printed by the first recording unit 7a changes in accordance with the scaling of the recording medium due to drying. Note that the adjustments of the recording position may be performed in the second recording unit 7b instead of the first recording unit 7a, or both units may be assigned with a part of the adjustments. To adjust the recording position according to the scaling of the recording medium, there is a method, for example, in which the image reading/calculating unit 403 calculates the amount of scaling of the maintenance pattern printed by the first recording unit 7a, and the image processing unit 401 performs scaling processing on the recording data for the first recording unit 7a. Another method is to have the image reading/calculating unit 403 calculate the amount of scaling of the maintenance pattern printed by the first recording unit 7a, and have the print control unit 402 adjust the ejection timing of the first recording unit 7a. The amount of scaling of the maintenance pattern printed by the first recording unit 7a can be calculated from the misregistration between the maintenance pattern printed by the first recording unit 7a and the maintenance pattern printed by the second recording unit 7b. Details are described later.

The maintenance unit 15 is a unit equipped with a mechanism for restoring the ejection performance of the recording head 22. Mechanisms for recovering the ejection performance may include, for example, a cap mechanism that protects the ink ejection surfaces of the recording heads 22, a wiper mechanism that wipes the ink ejection surfaces, a suction mechanism that applies negative pressure to suction ink from inside the recording heads 22 through the ink ejection surfaces, and the like. Further, the maintenance unit 15 is equipped with a drive mechanism and rail, which are not illustrated in the drawings, and is capable of reciprocating movement along the rail in the horizontal direction. The maintenance unit 15 moves to a position immediately below the recording heads 22 only at the time of performing the maintenance, and moves to a position away from immediately below the recording heads 22 at other times. In the present embodiment, the first maintenance unit 15a and the second maintenance unit 15b are installed so as to correspond to the first recording unit 7a and the second recording unit 7b, respectively.

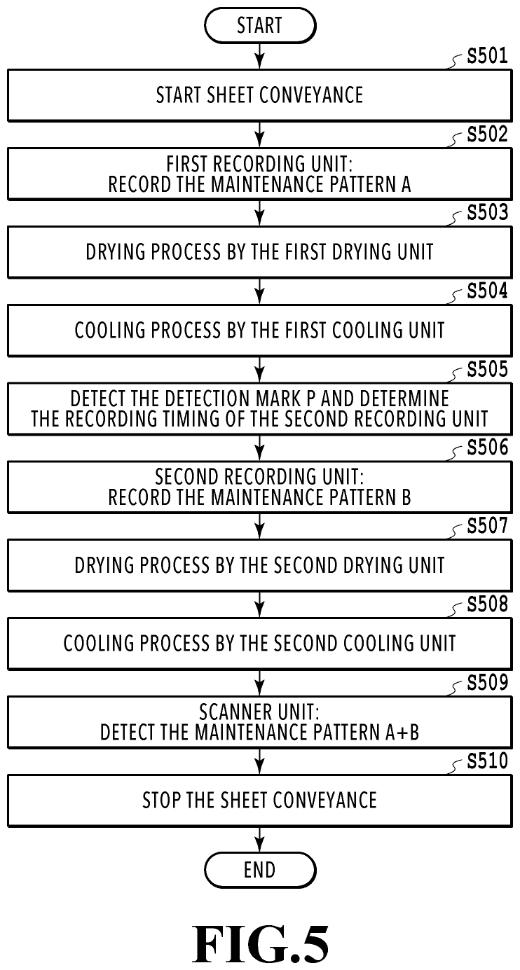

FIG. 5 shows a flowchart for explaining the operation from recording a maintenance pattern on the recording medium (the sheet S) to reading the recorded maintenance pattern in the printing apparatus according to the present embodiment.

In S501, the control unit 31 starts conveying the sheet S using the conveyance mechanism.

In S502, once the sheet S reaches a certain speed, the control unit 31 starts recording the later-described maintenance pattern A, which is composed of the reactive liquid and the white ink, on the sheet S using the first recording unit 7a. The maintenance pattern A includes the detection mark P that is detected by the second conveyance detection unit 6b and the scanner unit 11.

In S503, the control unit 31 causes the first drying unit 40a to perform the drying process on the portion where the maintenance pattern A is recorded in the sheet S.

In S503, the control unit 31 causes the first cooling unit 50a to perform the cooling process on the portion where the maintenance pattern A is recorded and dried in the sheet S.

The maintenance pattern A is heated and dried by the first drying unit 40a in S503, cooled by the first cooling unit 50a in S504, and then reaches the upstream side of the second recording unit 7b. By undergoing the heating and cooling processes in this manner, the sheet S is slightly deformed in both the same direction as the conveyance direction and the direction perpendicular to the conveyance direction, and the maintenance pattern A is also deformed along with the deformation of the sheet S.

In S505, once the maintenance pattern A reaches the upstream side of the second recording unit 7b, where the second conveyance detection unit 6b detects the detection mark P, the control unit 31 determines the recording timing of the image for the second recording unit 7b.

In S506, the control unit 31 starts recording the maintenance pattern B, which is composed of the reactive liquid and the color inks (C, M, Y, K, and spot colors), over the maintenance pattern A on the sheet S using the second recording unit 7b in accordance with the recording timing determined in S505. As a result, the maintenance pattern A and maintenance pattern B are formed on the sheet S, overlapping each other. At this time, the portion where the maintenance pattern A is printed in the sheet S expands/contracts slightly due to the heating and cooling processes, and the maintenance pattern A also expands/contracts along with the scaling of the sheet S, resulting in a color misregistration between the maintenance pattern A and the maintenance pattern B.

In S507, the control unit 31 causes the second drying unit 40b to perform the drying process on the portion where the maintenance patterns A and B are recorded in the sheet S.

In S508, the control unit 31 causes the second cooling unit 50b to perform the cooling process on the portion where the maintenance patterns A and B are recorded and dried in the sheet S.

In S509, triggered by the detection of the detection mark P by the scanner unit 11, the control unit 31 causes the scanner unit 11 to detect the maintenance patterns A and B.

In S510, once the maintenance patterns A and B are conveyed to the winding unit 14, the control unit 31 stops the conveyance of the sheet S.

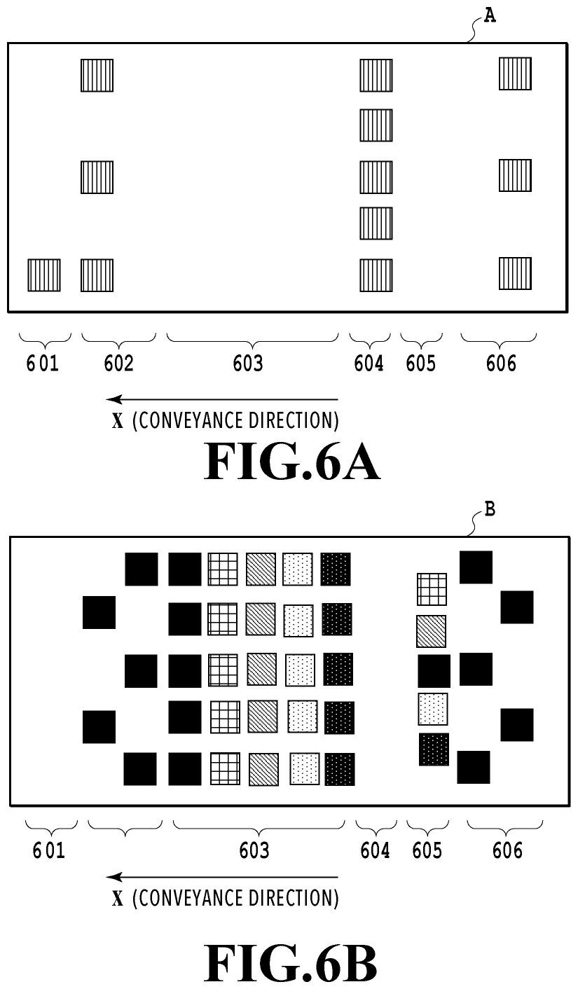

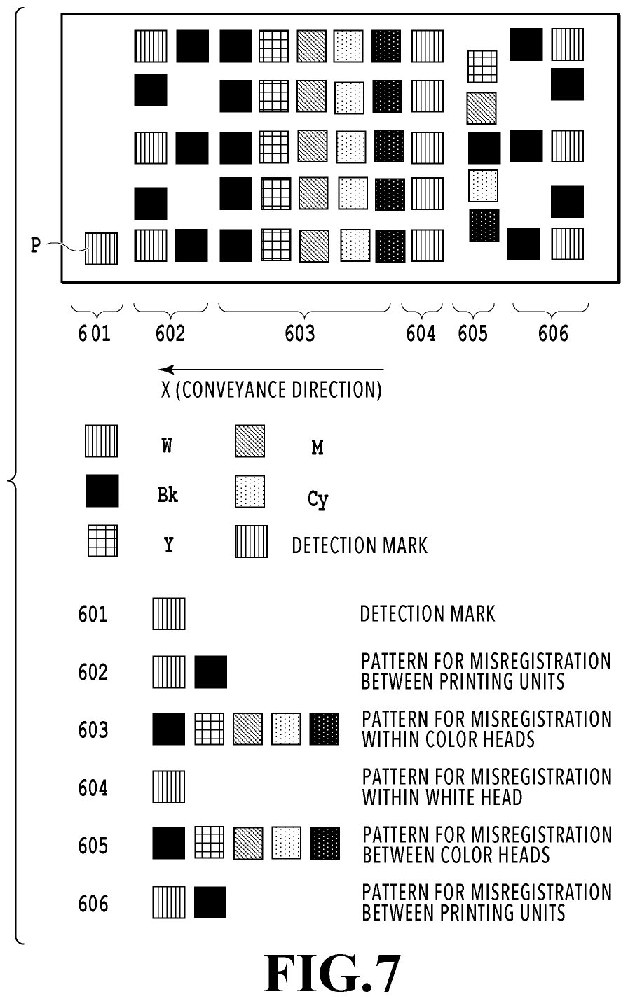

In FIG. 6A, FIG. 6B, and FIG. 7, the maintenance pattern used in the present embodiment are illustrated. As illustrated in FIG. 6A and FIG. 6B, the maintenance pattern is formed by printing the maintenance pattern A (FIG. 6A), which is composed of the reactive liquid and the white ink, and the maintenance pattern B (FIG. 6B), which is composed of the reactive liquid and the color inks, in an overlapping manner (FIG. 7). As illustrated in FIG. 6A, FIG. 6B, and FIG. 7, the maintenance pattern is divided into the areas 601 to 606 in order from the upstream side in the conveyance direction.

In the area 601, the detection mark P is recorded in white ink. The areas 602 to 606 are each recorded by the first recording unit 7a and the second recording unit 7b, triggered by the detection of the detection mark P by the second conveyance detection unit 6b.

In the area 602, the pattern for misregistration between the recording units, which is a combination of multiple white (W) and color (Bk) patterns, is recorded to detect the relative shift between the recording positions of the first recording unit 7a and the second recording unit 7b. From the area 602, the misregistration between the recording units, which is the shift between the recording positions of the first recording unit 7a and the second recording unit 7b, can be read, triggered by the detection of the detection mark P by the second conveyance detection unit 6b. During the reading of this misregistration between the recording units, the misregistration in the white (W) recording head 22 of the first recording unit 7a and the misregistration in the color (Bk) recording head 22 of the second recording unit 7b, which are read in a different area, are reflected. The misregistration within a recording head is caused by fluctuations in the positional relationship between the recording chips or between the nozzle rows of each recording head 22. Further, from the area 602, it is possible to read the misregistration between the recording units in the width direction, which is caused by the scaling of the sheet S in the width direction due to heating and cooling by the first drying unit 40a and the first cooling unit 50a.

In the area 603, the pattern for misregistration within the color recording heads, which is a combination of multiple Bk, Y, M, Cy, and spot color patterns, is recorded. From the area 603, it is possible to read the shift of the recording position caused by fluctuations in the positional relationship between the recording chips or between the nozzle rows within the recording head 22 for each color ink of the second recording unit 7b.

In the area 604, the pattern for misregistration within the white recording head, a combination of multiple W patterns, is recorded. From the area 604, it is possible to read the shift of the recording position caused by fluctuations in the positional relationship between the recording chips or between the nozzle rows within the W ink recording head 22 of the first recording unit 7a.

In the area 605, the pattern for misregistration between the color recording heads, which is a combination of multiple Bk, Y, M, Cy, and spot color patterns, is recorded. It is possible to read the shift between the recording positions of the color recording heads 22 (Bk, Y, M, Cy, and the spot colors) of the second recording unit 7b.

In the area 606, the pattern for misregistration between the recording units, which is a combination of multiple white (W) and color (Bk) patterns, is recorded. The pattern for misregistration between the recording units in the area 606 is a pattern formed by inverting the pattern for misregistration between the recording units in the area 602 in the sheet conveyance direction (left and right in FIG. 6A and FIG. 6B and FIG. 7 are inverted). Therefore, from the area 606, the same misregistration as in the area 602 can be read. In addition, from the area 606, the misregistration between the recording units caused by the scaling of the sheet S in the conveyance direction and the width direction due to heating and cooling by the first drying unit 40a and the first cooling unit 50a is to be read. The misregistration between the recording units caused by the scaling of the sheet S in the conveyance direction is read in the area 606 since the amount of scaling of the sheet S in the conveyance direction becomes larger as the distance from the detection mark P increases. Therefore, it is easier in the area 606 to read the misregistration between the recording units caused by the scaling of the sheet S in the conveyance direction than in the area 602, and the reading can be performed with high accuracy.

Further, at the time of the recording of the maintenance pattern A on the sheet S, a pattern (not illustrated in the drawings) where an average and uniform amount of white ink is deposited as in actual printing is printed outside the printing areas of the maintenance patterns A and B. This pattern is intended to reproduce the scaling caused by the latent heat of the white ink as the sheet S and the ink undergo the heating and cooling performed by the first drying unit 40a and the first cooling unit 50a in actual printing, rather than in test printing. This makes it possible to reduce the difference in conditions between test printing and actual printing, and to reduce the error between the misregistration amounts calculated from the maintenance patterns A and B and the misregistration amounts in actual printing. Note that, although the above describes the example in which only white ink is used, it is also possible to use both white ink and color inks. In that case, it is possible to better emulate actual printing.

Note that, although the maintenance pattern of the present embodiment is illustrated in FIG. 6A and FIG. 6B and FIG. 7 and explained as described above, the order of the areas 601 to 606 is not limited as such, and the order may be rearranged or partially omitted. Further, different maintenance patterns may be combined, or the maintenance pattern may be divided, so that the divided patterns are arranged at intervals from one another. For example, if the maintenance pattern is specialized for correcting the misregistration between the recording units (the color misregistration) caused by the scaling of the sheet S due to heating and cooling, then it is sufficient to use only the correction patterns in the areas 601, 602, and 606. In this case, the interval between the area 602 and the area 606 may be set appropriately depending on the correction accuracy.

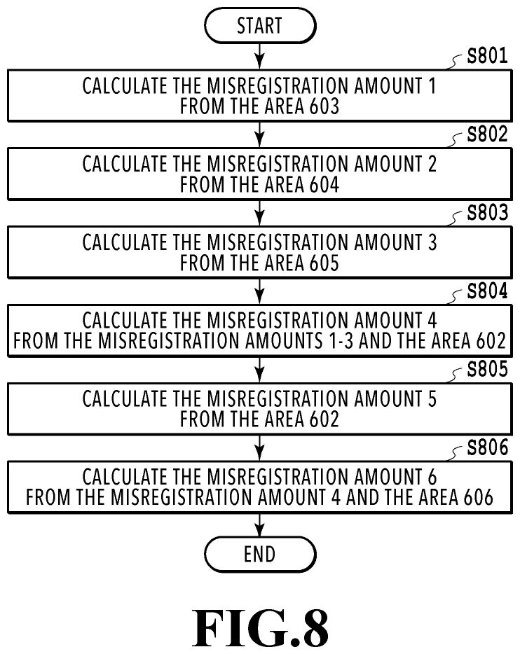

FIG. 8 shows a flowchart for explaining the method for calculating various misregistration amounts from the maintenance pattern in the present embodiment. Note that the misregistration amounts may be calculated as the differences at a predetermined position, such as the center between corresponding patterns or a specific edge. However, the method for calculating the misregistration amounts is not limited to this, and other existing calculation methods can also be used.

In S801, based on the pattern for the misregistration within the color recording heads detected in the area 603, the misregistration amount 1 within each of the recording heads included in the second recording unit 7b is calculated. That is, the misregistration amount 1 includes the misregistration amounts for Bk, Y, M, Cy, and each of the spot colors.

In S802, based on the pattern for the misregistration within the white recording head detected in the area 604, the misregistration amount 2 in the white (W) recording head 22 of the first recording unit 7a is calculated.

In S803, based on the pattern for the misregistration between the color recording heads detected in the area 605, the misregistration amount 3 between the recording heads 22 of different colors included in the second recording unit 7b is calculated. Note that the misregistration amount 3 may be calculated by, for example, using Bk as a reference, and calculating the misregistration amounts between the Bk recording head 22 and the recording heads 22 of the other colors.

In S804, based on the pattern for misregistration between the recording units detected in the area 602 and the misregistration amounts 1 and 2 calculated in S801 and S802, the misregistration amount 4 between the recording units, i.e., the first recording unit 7a and the second recording unit 7b, is calculated. More specifically, the misregistration amount 4 is the misregistration mount between the white (W) recording head 22 of the first recording unit 7a and the Bk recording head 22 of the second recording unit 7b.

In S805, based on the pattern for misregistration between the recording units detected in the area 602 and the misregistration amounts 1 and 2 calculated in S801 and S802, the misregistration amount 5 between the recording units caused by the scaling of the sheet S in the width direction due to heating and cooling is calculated. The herein-mentioned heating and cooling is performed by the first drying unit 40a and the first cooling unit 50a.

In S806, based on the pattern for misregistration between the recording units detected in the area 606 and the misregistration amount 4 calculated in S804, the misregistration amount 6 between the recording units caused by the scaling of the sheet S in the conveyance direction due to heating and cooling is calculated. In the maintenance pattern in the present embodiment, the areas 602 to 605 are arranged between the area 601 and the area 606, so that a long distance is ensured for calculating the amount of the scaling of the sheet S. Therefore, the amount of the scaling in the conveyance direction of the sheet S to be read becomes large, and thus the scaling rate can be calculated with high accuracy.

In this manner, with the maintenance pattern in the present embodiment, multiple types of misregistration amounts can be calculated with one maintenance pattern.

Next, an explanation is given of the registration adjustment method in the present disclosure, wherein the misregistration amounts 501 to 506 calculated by the image reading/calculating unit 403 are reflected in actual printing through the image processing unit 401 and the print control unit 402.

The image reading/calculating unit 403 outputs the calculated value of the misregistration amount 1 within the recording heads of the second recording unit to the print control unit 402. The print control unit 402 corrects the ejection timing of each nozzle for each of the recording heads 22 of the second recording unit 7b, based on the input misregistration amount 1.

The image reading/calculating unit 403 outputs the calculated value of the misregistration amount 2 within the recording head of the first recording unit 7a to the print control unit 402. The print control unit 402 corrects the ejection timing of each nozzle of the white (W) recording head 22 of the first recording unit 7a, based on the input misregistration amount 2.

The image reading/calculating unit 403 outputs the calculated value of the misregistration amount 3 between the color recording heads of the second recording unit 7b to the print control unit 402. The print control unit 402 corrects the ejection timing between the recording heads of different colors of the second recording unit 7b, based on the input misregistration amount 3.

The image reading/calculating unit 403 outputs the misregistration amount 4 between the recording units, i.e., the first recording unit 7a and the second recording unit 7b, to the print control unit 402. The print control unit 402 corrects the ejection timing of each recording head 22 in the second recording unit 7b, based on the input misregistration amount 4, triggered by the detection of the detection mark P by the conveyance detection unit 6.

The image reading/calculating unit 403 outputs, to the image processing unit 401, the calculated value of the misregistration amount 5 between the recording units caused by the scaling of the sheet S in the width direction due to heating and cooling by the first drying unit 40a and the first cooling unit 50a. The image processing unit 401 calculates the scaling rate in the width direction based on the input misregistration amount 5 and the distance between the Bk patterns arranged in the width direction in the area 602, and, based on the calculated scaling rate, performs a process of scaling the image data for the first recording unit 7a in the width direction. Note that the scaling rate may be calculated by the image reading/calculating unit 403 and output to the image processing unit 401. In this case, the image processing unit 401 performs the process of scaling the image data based on the input scaling rate without calculating the scaling rate.

The image reading/calculating unit 403 outputs, to the image processing unit 401, the calculated value of the misregistration amount 6 between the recording units caused by the scaling of the sheet S in the conveyance direction due to heating and cooling by the first drying unit 40a and the first cooling unit 50a. The image processing unit 401 calculates the scaling rate in the conveyance direction based on the input misregistration amount 6 and the distance from the detection mark P to the area 606, and, based on the calculated scaling rate, performs the process of scaling the image data for the first recording unit 7a in the conveyance direction. Note that, instead of the process of scaling the image data in the conveyance direction, the ejection frequency of the recording head 22 of the first recording unit 7a may be adjusted based on the calculated scaling rate.

Note that, instead of performing the process based on the above-mentioned scaling rate on the image data for the first recording unit 7a or the recording head 22 of the first recording unit 7a, the process may be performed on the image data for the second recording unit 7b or the recording heads 22 of the second recording unit 7b. In this case, the process of scaling the image data for the second recording unit 7b or the adjustment of the ejection frequency of the recording heads 22 of the second recording unit 7b may be performed based on the calculated scaling rate, so as to align with the image printed by the first recording unit 7a, which has been distorted due to the scaling of the sheet S.

Further, the image processing unit 401 may hold scaling information including scaling rates for the respective types of sheet S, and perform registration adjustments, such as the above-mentioned process of scaling the image data or adjustment of the ejection frequency, based on the scaling rate corresponding to the type of sheet S received from the user, for example. In this case, the process of calculating the scaling rate of the recording medium from the maintenance pattern can be omitted.

Note that the sheet conveyance may be stopped temporarily after printing the maintenance pattern, and the registration adjustment involving the reflecting of the above-mentioned misregistration amounts 501 to 506 in printing may be performed at the time of performing normal printing after accepting a normal print job. Alternatively, after printing the maintenance pattern, the registration adjustment may be performed at the time the normal printing is performed continuously without stopping the sheet conveyance.

With the above-described configuration, it is possible to record high definition images with little color misregistration in a printing apparatus in which a recording unit is divided into white and color and a drying unit is installed between the white recording unit and the color recording unit.

In the present embodiment, an explanation is given of the configuration in which the recording heads of an inkjet scheme are used as the first recording unit 7a and the second recording unit 7b, but a printing apparatus using another recording scheme may also be used. Further, in the first embodiment, white ink is used in the first recording unit 7a and color inks are used in the second recording unit 7b, but the ink configuration is not limited as such, and other ink configurations may also be used. That is, the present embodiment makes it possible to print high definition images with little color misregistration as long as the printing apparatus is equipped with multiple recording units and a drying unit between the recording units.

Further, although so far an explanation has been given of the present embodiment as the printing apparatus 1, it is not necessary to include the entire printing apparatus 1. It is sufficient if the configuration allows a printing apparatus to at least carry out the processing of the image processing unit 401, the print control unit 402, and the image reading/calculating unit 403.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)198 ), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, it is possible to reduce color misregistration in a printing apparatus that carries out a drying process between printing processes.

This application claims the benefit of Japanese Patent Application No. 2024-026249 filed Feb. 26, 2024, which is hereby incorporated by reference wherein in its entirety.

What is claimed is:

1. A printing apparatus comprising:
a first recording unit configured to record a first image on a front surface of a recording medium, which has the front surface and a back surface;
a drying unit configured to dry the recording medium on which the first image is recorded by the first recording unit;
a second recording unit configured to record a second image on the front surface of the recording medium dried by the drying unit; and
a control unit configured to control a recording position of the first recording unit or a recording position of the second recording unit in accordance with scaling of the recording medium caused by being dried by the drying unit.

2. The printing apparatus according to claim 1,
wherein the control unit controls the recording position of the first recording unit by controlling a position and size where the recording of the first image is started.

3. The printing apparatus according to claim 1,
wherein the control unit controls the recording position by changing an ejection frequency of a recording head of the first recording unit.

4. The printing apparatus according to claim 1, further comprising:
an acquisition unit configured to acquire a read image obtained by reading the images recorded by the recording units,
wherein the control unit causes the first recording unit and the second recording unit to record a maintenance pattern, and controls the recording position of the first recording unit based on an scaling rate of the recording medium, which is calculated from the read image obtained by reading the recording medium on which the maintenance pattern is recorded and acquired by the acquisition unit.

5. The printing apparatus according to claim 4,
wherein the maintenance pattern includes two first patterns for adjusting a relative shift between the recording positions of the first recording unit and the second recording unit, and
the control unit calculates the scaling rate of the recording medium from the two first patterns.

6. The printing apparatus according to claim 5,
wherein the two first patterns are arranged at a predetermined interval in a conveyance direction of the recording medium.

7. The printing apparatus according to claim 5,
wherein the control unit calculates the scaling rate of the recording medium in the conveyance direction based on the two first patterns and a distance between the two first patterns in the conveyance direction of the recording medium.

8. The printing apparatus according to claim 5,
wherein the first recording unit and the second recording unit include a recording head of an inkjet scheme.

9. The printing apparatus according to claim 8,
wherein the maintenance pattern includes the first patterns and a second pattern for performing adjustment of a recording position within the recording head.

10. The printing apparatus according to claim 9, wherein the second pattern is arranged between the two first patterns.

11. The printing apparatus according to claim 5,
wherein the control unit performs adjustment of the recording positions in a width direction, which is perpendicular to the conveyance direction of the recording medium, based on at least one of the two first patterns.

12. The printing apparatus according to claim 4, further comprising:
a detection unit configured to detect a detection mark included in the maintenance pattern recorded by the first recording unit, and
wherein the control unit starts recording by the second recording unit according to detection of the detection mark by the detection unit.

13. The printing apparatus according to claim 1,
wherein the control unit holds an scaling rate for each type of recording medium and controls the recording position of the first recording unit based on the scaling rate corresponding to the type of the recording medium.

14. The printing apparatus according to claim 1,
wherein the control unit controls the recording positions by scaling the image to be recorded by the first recording unit.

15. A printing method comprising:
a step for recording a first image on a front surface of a recording medium, which has the front surface and a back surface;
a step for drying the recording medium on which the first image is recorded;
a step for recording a second image on the front surface of the recording medium dried in the step for drying; and
a step for controlling a recording position in the step for recording the first image or a recording position in the step for recording the second image according to scaling of the recording medium caused by being dried by the step for drying.

16. A non-transitory computer-readable storage medium storing a program for causing a computer to execute a printing method, the printing method comprising:
a step for recording a first image on a front surface of a recording medium, which has the front surface and a back surface;
a step for drying the recording medium on which the first image is recorded;
a step for recording a second image on the front surface of the recording medium dried in the step for drying; and
a step for controlling a recording position in the step for recording the first image or a recording position in the step for recording the second image according to scaling of the recording medium caused by being dried by the step for drying.
